(19) United States
(12) Patent Application Publication
(10) Pub. No.: US 2020/0225365 A1
(43) Pub. Date: Jul. 16, 2020

(54) METHOD FOR LOCALIZING A MORE HIGHLY AUTOMATED VEHICLE AND CORRESPONDING DRIVER ASSISTANCE SYSTEM AND COMPUTER PROGRAM

(71) Applicant: Robert Bosch GmbH, Stuttgart (DE)

(72) Inventors: Carsten Hasberg, Ilsfeld-Auenstein (DE); Philipp Rasp, Wannweil (DE)

(21) Appl. No.: 16/628,882

(22) PCT Filed: Jun. 4, 2018
(86) PCT No.: PCT/EP2018/064648

§ 371 Date: Jan. 6, 2020

(30) Foreign Application Priority Data
Jul. 7, 2017 (DE) 10 2017 211 605.6

(51) Int. Cl. G01S 19/45; G08G 1/133; G01C 21/30; G01S 19/14; H04W 4/40; H04W 4/029

(52) U.S. Cl. CPC G01S 19/45; G08G 1/133; H04W 4/029; G01S 19/14; H04W 4/40; G01C 21/30

(57) ABSTRACT

A method for operating a more highly automated vehicle (HAF), in particular a highly automated vehicle, including: S1—providing a digital map, which may be a highly accurate digital map, in a driver assistance system of the HAF; S2—providing at least one reference measuring point that is geodetically measuring in a highly accurate manner, positional data of the reference measuring point being stored in the digital map; S3—determining a current reference vehicle position by using the reference measuring point; S4—determining a current satellite vehicle position by using a global satellite navigation system (GNSS); and S5—comparing the reference vehicle position with the satellite vehicle position and ascertaining a GNSS error as a result of the comparison. Also described is a corresponding system and a computer program.

### FIELD OF THE INVENTION

The present invention relates to a method for localizing a more highly automated vehicle (HAF), in particular a highly automated vehicle, in a digital map and to a driver assistance system for controlling a more highly automated vehicle (HAF), in particular a highly automated vehicle.

### BACKGROUND INFORMATION

In view of an increase of the degree of automation of vehicles, more and more complex driver assistance systems are used. Such driver assistance systems and functions, such as e.g. highly automated driving or fully automated driving, require a great number of sensors in the vehicle, which allow for an exact detection of the environment of the vehicle.

More highly automated is understood below as all those degrees of automation that correspond, in the sense of the Bundesanstalt für Straβenwesen (BASt) [Federal Highway Research Institute], to an automated longitudinal and lateral guidance with increasing system responsibility, e.g. highly and fully automated driving.

The related art discloses a multitude of possibilities of implementing a method for localizing a more highly automated vehicle (HAF), in particular a highly automated vehicle. Thus, localization methods are known for example, which are based on a combination of GNSS global satellite navigation systems, such as for example GPS, GLONASS or Galileo, and driving dynamics sensors, such as for example yaw-rate sensors, acceleration sensors, steering wheel angle sensors or wheel speed sensors. As is known, a decisive factor for the accuracy of a GNSS-based vehicle localization is the quality of the GNSS resolution, which however is subject to fluctuations in location and over time. This accuracy can be improved by corrective services.

A known method uses reference stations on the terrestrial surface, whose position has been measured geodetically in a highly accurate manner. On the basis of current measurements of the GNSS signals at the reference stations, it is possible to determine a local, current GNSS inaccuracy. Thus it is possible to indicate for each reference station a current GNSS error obtaining in that location. In order to be able to determine the GNSS error at any arbitrary position of an area, the GNSS errors are interpolated between the reference stations.

If the GNSS errors obtaining in the respective locations and at the respective times are now provided to more highly automated vehicles in the position determination, it is possible to perform an improved position determination by correcting the vehicle position indicated by the GNSS module for the GNSS error.

Although this method provides satisfactory results with respect to the accuracy of the vehicle localization, it nevertheless has several disadvantages. These include, among others, a partially limited availability, since for transmitting the GNSS errors to the more highly automated vehicles, an OTA (over-the-air) transmission is required, which cannot be guaranteed at every location, and high costs due to the operation and equipment of the reference stations.

Furthermore, it has proved disadvantageous that the improved GNSS accuracy diminishes with increasing distance of the vehicle from one of the reference stations due to interpolation errors in the determination of the locally obtaining GNSS error.

It is therefore an objective of the present invention to provide an improved method for operating a more highly automated vehicle (HAF), in particular a highly automated vehicle, and an improved driver assistance system for controlling a more highly automated vehicle (HAF), in particular a highly automated vehicle, by which the disadvantages mentioned above are at least improved upon and which represents an alternative to conventional GNSS correction services.

### SUMMARY OF THE INVENTION

This objective is achieved by the respective subject matter described herein. Advantageous developments of the present invention are the subject matter of the respective further descriptions herein.

According to one aspect of the present invention, a method is provided for localizing a more highly automated vehicle (HAF), in particular a highly automated vehicle, in a digital map, comprising the following steps:
S1 providing a digital map, which may be a highly accurate digital map, in a driver assistance system of the HAF;
S2 providing at least one reference measuring point measured by high-accuracy geodetic measurement, positional data of the reference measuring point being stored in the digital map;
S3 determining a current reference vehicle position by using the reference measuring point;
S4 determining a current satellite vehicle position by using a global satellite navigation system (GNSS); and
S5 comparing the reference vehicle position with the satellite vehicle position and ascertaining a GNSS error as a result of the comparison.

Suitable locations for the reference measuring points provided in step S2 are characterized by very good coverage by global satellite navigation systems (GNSS), which means that at these locations there should be no obstruction of satellite reception and no multipath effects. Furthermore, these locations should offer a sufficiently high density of good measurable and identifiable reference measuring points.

Accordingly, it is advantageous if for example road markers, a curb, a delineator, guard rails, traffic lights and/or traffic signs are used as reference measuring points.

Fundamentally, the determination of the reference vehicle position in step S3 may be performed in a manner known per se by a localization method based on features, a so-called feature localization. For this purpose, it is conceivable for example that one or multiple sensors measure an angle of direction as well as a distance of the HAF from the reference measuring point, for example by radar distance measurement. Since the position of the reference measuring point is known, a control unit of the HAF is able to ascertain the reference vehicle position by basic geodetic methods using these sensor data as well as the position data of the reference measuring point.

For this purpose, it is conceivable that each reference measuring point actively emits an identifier, which is detected and identified by an HAF traveling in the area surrounding the reference measuring point. It is likewise conceivable that the reference measuring points in this manner also transmit their position to the driver assistance system of the HAF so that it is not necessary to store this position separately in the digital map. Whenever an HAF enters the vicinity of a reference measuring point equipped in this manner, its driver assistance system is alerted to the presence of the reference measuring point by the signal emitted by the reference measuring point and is supplied with the positional data of the reference measuring point. In one specific embodiment of the present invention, a driver assistance system may be equipped for this purpose with a receiver unit corresponding to the signal type, which may be integrated into the already mentioned sensor for detecting the reference measuring point.

The method of the present invention may include an additional step S6, in which at least one further satellite vehicle position is determined by using the global satellite navigation system (GNSS), the position information of the GNSS being corrected for the GNSS error.

In one specific embodiment, the method of the present invention furthermore includes the step S7 in which the current satellite vehicle position and/or the reference vehicle position as well as the ascertained GNSS error are transmitted to a server computer, the GNSS error is processed in a higher-order GNSS error model and the GNSS error model is made available to other more highly automated vehicles.

In another specific embodiment of the present invention, step S7 of the method furthermore comprises that additional more highly automated vehicles transmit respectively ascertained GNSS errors and current satellite vehicle positions and/or reference vehicle positions to the server computer, the GNSS error model being produced by taking into account a plurality of, which may be all of the transmitted GNSS errors.

For the further procedure, one specific embodiment of the present invention advantageously provides for the GNSS error model to be based on interpolation between the respectively transmitted GNSS errors.

For the HAF to identify the reference measuring point, suitable identifying features of the reference measuring point may be stored in the digital map.

Here it has proved advantageous that the reference measuring point is equipped with a transmitter, the transmitter emitting a signal, in particular a radio or radar signal, with an identifier of the reference measuring point, the signal being received by the HAF located in the area surrounding the reference measuring point.

The signal emitted by the transmitter also may comprise the positional data of the reference measuring point.

For proceeding further, one specific embodiment of the present invention advantageously provides for the reference measuring point to be a road marking, a curb, a delineator, a guard rail, traffic lights and/or a traffic sign.

Another subject matter of the present invention is a driver assistance system for controlling a more highly automated vehicle (HAF), in particular a highly automated vehicle, the driver assistance system comprising at least one sensor for detecting a reference measuring point in the surroundings of the HAF, a memory module for storing a digital map, which may be a highly accurate digital map, a GNSS position module for determining a satellite vehicle position of the HAF and a control unit. The memory module is in particular a memory module integrated into the HAF or a central server, the positional data of the reference measuring point being stored in the digital map. Furthermore, the GNSS position module operates according to a method of global satellite navigation (GNSS) and is in particular a GPS module. The control unit is configured to exchange data with the sensor, the memory module and the position module and to localize the vehicle position determined by the position module in the digital map. The present invention provides for the control unit to be configured to ascertain a reference vehicle position on the basis of sensor data provided by the sensor and on the basis of the positional data of the reference measuring point. Furthermore, the satellite vehicle position ascertained by the GNSS position module is compared to the reference vehicle position and a GNSS error is ascertained as the result of the comparison.

In a particular specific embodiment, when determining at least one additional satellite vehicle position by using the GNSS position module, the control unit is configured to correct the position information ascertained by the GNSS position module for the GNSS error.

Advantageously, the driver assistance system furthermore comprises a transmission module, the control unit being configured to transmit the current satellite vehicle position and/or the reference vehicle position as well as the ascertained GNSS error to a server computer.

The control unit may be configured to receive an ascertained GNSS error from a server computer and to take it into account when determining a GNSS vehicle position.

In one specific embodiment, the transmission module operates in accordance with a radio and/or vehicle-to-infrastructure (V2I) transmission method.

In one specific embodiment of the present invention, the at least one sensor is selected from the group of the following sensors: acceleration sensors, camera sensors, radar sensors, lidar sensors.

Furthermore, a computer program, comprising program code for implementing the method as recited in one of claims 1 through 7, when the computer program is executed on a computer, is also a subject matter of the present invention.

Although the present invention is described below chiefly in connection with passenger cars, it is not limited to these, but may be used with any kind of vehicle, cargo trucks and/or passenger cars.

Additional features, possible applications and advantages of the present invention result from the following description of exemplary embodiments of the present invention, which are shown in the FIGURE. It should be noted that the represented features only have a descriptive character and may also be used in combination with features of other developments described above and are not intended to limit the present invention in any form whatsoever.

The present invention is explained below in more detail with reference to an exemplary embodiment, the same reference symbols being used for identical features. The drawing is schematic.

### BRIEF DESCRIPTION OF THE DRAWING

FIG. 1 shows a flow chart of a first specific embodiment of the method according to the present invention.

### DETAILED DESCRIPTION

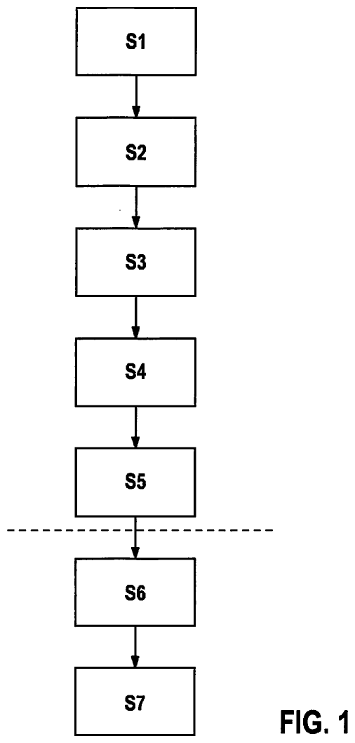

In step S1 of FIG. 1, a digital map, which may be a highly accurate digital map, is provided in a driver assistance system of an HAF, which may be done on the device side in a memory module for storing the digital map, the memory module being in particular a memory module integrated into the HAF or a central server.

In step S2, at least one, which may be however multiple reference measuring points, geodetically measured in a highly accurate manner, is/are provided, the positional data of the reference measuring points being stored as geo-coordinates in the digital map.

Suitable locations for situating reference measuring points are characterized by very good coverage by global satellite navigation systems (GNSS), which means that at these locations there should be no obstruction of satellite reception and no multipath effects. Furthermore, these locations should offer a sufficiently high density of good measurable and identifiable reference measuring points.

The reference measuring points themselves may be road markings, a curb, a delineator, guard rails, traffic lights, and/or traffic signs.

Step S3 comprises determining a current reference vehicle position by using the reference measuring point. On the side of the device, a driver assistance system in accordance with the present invention encompasses for this purpose at least one sensor that is suitable for detecting the reference measuring point in the surroundings of the vehicle. In a manner known per se, it is possible to use for this purpose a sensor from the group of camera sensors, radar sensors or lidar sensors. The determination of the reference vehicle position may be performed likewise in a manner known per se by a localization method based on features, a so-called feature localization. For this purpose, it is conceivable for example that one or multiple sensors measure an angle of direction as well as a distance of the HAF from the reference measuring point, for example by radar distance measurement. Since the position of the reference measuring point is known, a control unit of the HAF is able to ascertain the reference vehicle position by basic geodetic methods using these sensor data as well as the positional data of the reference measuring point.

In this connection, for the HAF to identify the reference measuring point, it is advantageous if suitable identifying features of the reference measuring point are stored in the digital map.

Likewise and alternatively, it is conceivable that each reference measuring point actively emits an identifier, for example via radio or radar, which is detected and identified by an HAF traveling in the area surrounding the reference measuring point. It is likewise conceivable that the reference measuring points in this manner also transmit their position to the driver assistance system of the HAF so that it is not necessary to store this position separately in the digital map. Whenever an HAF enters the vicinity of a reference measuring point equipped in this manner, its driver assistance system is alerted to the presence of the reference measuring point by the signal emitted by the reference measuring point and is supplied with the positional data of the reference measuring point. In one specific embodiment of the present invention, a driver assistance system may be equipped for this purpose with a receiver unit corresponding to the signal type, which may be integrated into the already mentioned sensor for detecting the reference measuring point.

In step S4, a current satellite vehicle position is determined by using a global satellite navigation system (GNSS). The GNSS may be for example a navigation system based on Naystar GPS, Glonass, Galileo, and/or Beidou. The driver assistance system is for this purpose equipped with a GNSS position module.

Since the GNSS resolution, as already mentioned at the outset, is subject to fluctuations in location and over time, there will generally be a deviation between the satellite vehicle position and the reference vehicle position.

In step S5, therefore, a comparison is performed between the reference vehicle position and the satellite vehicle position, and a GNSS error is ascertained as a result of the comparison. In the driver assistance system of the present invention, these steps are performed by the control unit, which is configured for this purpose, inter alia, to exchange data with the memory module, and the position module and the sensor.

In an advantageous development of the present invention, the method comprises the step of determining at least one further satellite vehicle position by using the global satellite navigation system (GNSS), the position information of the satellite navigation system (GNSS) being corrected for the GNSS error (S6). When the driver assistance of the present invention subsequently controls the HAF, the position information of the GNSS position module may be corrected for the GNSS error until a new reference measuring point is encountered, at which then steps S3-S5 of the method according to the present invention are performed anew.

In one specific embodiment of the present invention, the method may comprise a step S7, in which the current satellite vehicle position and/or the reference vehicle position as well as the ascertained GNSS error are transmitted to a server computer. The server computer is able to process the GNSS error in a higher-order GNSS error model, the GNSS error model advantageously being provided to additional more highly automated vehicles. For this purpose, the driver assistance system of the present invention may comprise a transmission module, the control unit of the driver assistance system being configured to transmit the current satellite vehicle position and/or the reference vehicle position as well as the ascertained GNSS error to the server computer. Conversely, the transmission module and the control unit are also configured to receive the corresponding information regarding the GNSS error from the server or from other vehicles located in the vicinity of the HAF. The transmission between two vehicles may be for example a vehicle-to-vehicle transmission (v2v).

An error model is to be understood here as a specification, valid in a specific area, regarding GNSS errors varying in space and/or over time, the correction of which allows for higher accuracy of the GNSS-based vehicle localization.

It is particularly advantageous if additional more highly automated vehicles in turn transmit respectively ascertained GNSS errors and current satellite vehicle positions and/or reference vehicle positions to the server computer, and if the GNSS error model is produced by taking into account a plurality of, which may be all, transmitted GNSS errors. In this manner, it is possible to obtain a dense network of information about the locally varying GNSS errors, which may be improved further via a corresponding interpolation between respectively transmitted GNSS errors.

The present invention is not limited to the exemplary embodiment shown. Rather, it also comprises all developments by those skilled in the art within the scope of the invention defined by the patent claims.

Besides the specific embodiments described and illustrated, additional specific embodiments are conceivable, which may include further variations as well as combinations of features.

1-16. (canceled)

17. A method for localizing a more highly automated vehicle (HAF) or a highly automated vehicle, in a digital map, the method comprising:
providing a digital map, which is a highly accurate digital map, in a driver assistance system of the HAF;
providing at least one reference measuring point measured by high-accuracy geodetic measurement, positional data of the reference measuring point being stored in the digital map;
determining a current reference vehicle position by using the reference measuring point;
determining a current satellite vehicle position by using a global satellite navigation system (GNSS); and
comparing the reference vehicle position with the satellite vehicle position and ascertaining a GNSS error as a result of the comparison.

18. The method of claim 17, further comprising:
determining at least one additional satellite vehicle position by using the global satellite navigation system (GNSS), the position information of the GNSS being corrected for the GNSS error.

19. The method of claim 17, further comprising:
transmitting the current satellite vehicle position and/or the reference vehicle position and the ascertained GNSS error to a server computer, and processing the GNSS error in a higher-order GNSS error model and providing the GNSS error model to additional more highly automated vehicles.

20. The method of claim 19, wherein in the transmitting, additional more highly automated vehicles transmit respectively ascertained GNSS errors and current satellite vehicle positions and/or reference vehicle positions to the server computer, the GNSS error model being produced by taking into account a plurality of, preferably all, transmitted GNSS errors.

21. The method of claim 20, wherein the GNSS error model is based on interpolation between the respectively transmitted GNSS errors.

22. The method of claim 17, wherein for the HAF to identify the reference measuring point, suitable identifying features of the reference measuring point are stored in the digital map.

23. The method of claim 17, wherein the reference measuring point is equipped with a transmitter, the transmitter emitting a signal, in particular a radio or radar signal, with an identifier of the reference measuring point, the signal being received by the HAF located in the area surrounding the reference measuring point.

24. The method of claim 23, wherein the signal emitted by the transmitter also comprises the positional data of the reference measuring point.

25. The method of claim 17, wherein the reference measuring point includes at least one of a road marker, a curb, a delineator, a guardrail, a traffic light and/or a traffic sign.

26. A driver assistance system for controlling a more highly automated vehicle (HAF), in particular of a highly automated vehicle, comprising
at least one sensor for detecting a reference measuring point in the surroundings of the HAF;
a memory module for storing a digital map, which is a highly accurate digital map, the memory module being in particular a memory module integrated in the HAF or a central server, and positional data of the reference measuring point being stored in the digital map;
a GNSS position module for determining a satellite vehicle position of the HAF, the GNSS position module operating according to a method of global satellite navigation (GNSS) and being in particular a GPS module;
a control unit to exchange data with the sensor, the memory module and the position module and to localize the vehicle position determined by the position module in the digital map,
wherein the control unit is configured to perform the following:
ascertaining a reference vehicle position on the basis of sensor data provided by the sensor and on the basis of the positional data of the reference measuring point;
comparing the satellite vehicle position ascertained by the GNSS position module with the reference vehicle position; and
ascertaining a GNSS error as a result of the comparison.

27. The driver assistance system of claim 26, wherein, when determining at least one additional satellite vehicle position by using the GNSS position module, the control unit is configured to correct the position information ascertained by the GNSS module for the GNSS error.

28. The driver assistance system of claim 26, further comprising:
a transmission module, wherein the control unit is configured to transmit the current satellite vehicle position and/or the reference vehicle position and the ascertained GNSS error to a server computer.

29. The driver assistance system of claim 28, wherein the control unit is configured to receive an ascertained GNSS error from a server computer and to take it into account when determining a GNSS vehicle position.

30. The driver assistance system of claim 28, wherein the transmission module operates according to one of the following transmission methods: radio, and vehicle-to-infrastructure (V2I).

31. The driver assistance system of claim 26, wherein the at least one sensor includes at least one of a camera sensor, a radar sensor, and/or a lidar sensor.

32. A non-transitory computer readable medium having a computer program, which is executable by a processor, comprising:
a program code arrangement having program code for localizing a more highly automated vehicle (HAF) or a highly automated vehicle, in a digital map, by performing the following:
providing a digital map, which is a highly accurate digital map, in a driver assistance system of the HAF;
providing at least one reference measuring point measured by high-accuracy geodetic measurement, positional data of the reference measuring point being stored in the digital map;
determining a current reference vehicle position by using the reference measuring point;
determining a current satellite vehicle position by using a global satellite navigation system (GNSS); and
comparing the reference vehicle position with the satellite vehicle position and ascertaining a GNSS error as a result of the comparison.
